(19) United States
(12) Patent Application Publication
(10) Pub. No.: US 2018/0032621 A1
(43) Pub. Date: Feb. 1, 2018

(54) LOCATION AND SOCIAL AWARE, MULTI-DIMENSIONAL, DYNAMIC, POSITIVE RECOMMENDATIONS

(71) Applicant: YUPPR, INC., Carlsbad, CA (US)

(72) Inventor: Amine Belabbes NABI, Carlsbad, CA (US)

(73) Assignee: YUPPR, INC., CARLSBAD, CA (US)

(21) Appl. No.: 15/665,306

(22) Filed: Jul. 31, 2017

Related U.S. Application Data
(60) Provisional application No. 62/369,595, filed on Aug. 1, 2016.

(51) Int. Cl. G06F 17/30

(52) U.S. Cl. CPC G06F 17/30867; G06F 17/30876

(57) ABSTRACT

A method and system for an online recommendation based social media network, designed to bring people together, through providing and receiving multi-dimensional, dynamic, personal recommendations. A user initiates one of the following actions: Share, get or ask for recommendations on businesses or places based on their location, products from third party, also based on the location. As well as media content such as but not limited to movies, videos, music and other types of recommendations such as books, articles, recipes, websites, mobile apps. A recommendation has a multitude of dimensions that help prospective users make a smart decision whether or not to use this recommendation, such dimensions include type of the recommendation (Business, product, movie, recipe, etc. . . . ), a proprietary scale “Yupping” of how much the user likes it: Good, great or awesome. A set of pre-defined positive reasons stating what they like about it, a comment to describe their own experience in a textual manner, a picture or video to describe their own experience in a visual manner, external links to get extra information about the recommendation or give purchase or viewing options, a geo location (when applicable), contact information (when applicable), and every other person inside or outside of the user's network multi-dimensional aspects of this recommendation. The user can also ask for a recommendation, and can be recommended themselves. The user being a recommendation derives directly from their profession and a bio, that they have entered to market themselves and also a reputation based how many of their recommendations people liked and how much they liked them.

### CROSS-REFERENCE TO RELATED APPLICATIONS

The present invention claims priority to U.S. Provisional Patent Application No. 62/369,595, filed Aug. 1, 2016, which is hereby incorporated in its entirety including all tables, figures, and claims.

### BACKGROUND

### Field of the Invention

The present invention is intended to utilize location and socially aware, multi-dimensional, dynamic, recommendations in a mobile app on a social media network platform.

### Description of the Related Art

Five figures have been provided that relate to the items found in Claims.

### SUMMARY

The present invention comprises a method and system in which a group of friends can share, get and ask for recommendations with and from each other in an organized, trusting and information rich way.

In one embodiment of the present invention, the system allows people to come together for one purpose: To exchange recommendations that matter to them, based on location and interest, and with a multitude of dimensions.

In a second embodiment of the present invention, the system allows a person to give a recommendation to their peers covering different aspects of the recommendation, such as how much they like it, why they like it, giving their own experience of the recommendation and providing a multitude of dimensions related to this recommendation with the intention to help other users make smart decisions.

In a third embodiment of the present invention, the system allows the user to search and browse through recommendations provided by their friends or other people.

In a fourth embodiment of the present invention, the system dynamically generates recommendation to the user based on their interests and recommendations they have made or liked previously.

In a fifth embodiment of the present invention, the system allows a person to ask for recommendations from their friends and get dynamically generated recommendations based on similarities with what they are asking for.

### BRIEF DESCRIPTION OF THE DRAWINGS

FIG. 1: Illustrates people, using the mobile app and website of the current invention, connecting through their devices (Mobile or desktop) to the cloud of this current invention, to share, get and ask for multi-dimensional and dynamic recommendations.

FIG. 2: Illustrates a person (User of the current invention) sharing a multi-dimensional and dynamic recommendation

FIG. 3: Illustrates a person (User of the current invention) getting a multi-dimensional and dynamic recommendation

FIG. 4: Illustrates a person (User of the current invention) asking for a multi-dimensional and dynamic recommendation

FIG. 5: Illustrates the multi dimensions of a recommendation of this current invention.

### DETAILED DESCRIPTION

Embodiments of the present invention comprise a method and a system that allows people to share, get and ask for multi-dimensional and dynamic recommendations.

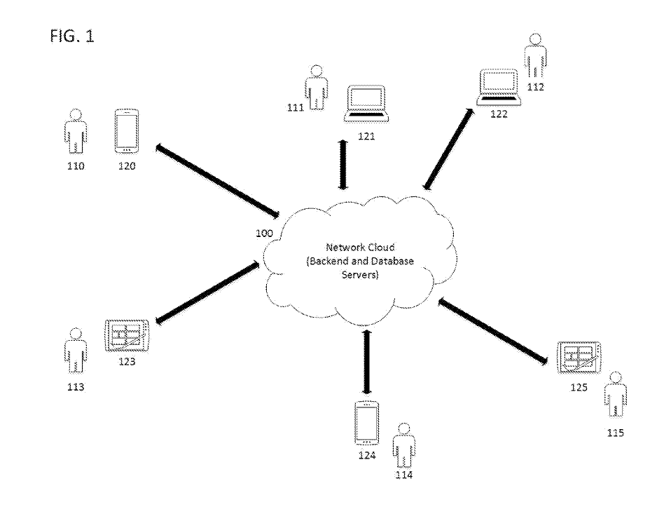

Referring to drawing in FIG. 1, the network cloud 100 of the current invention, which is comprised of backend servers and database servers, connects people together, through their mobile devices or desktop computers, in order to share, get and ask for recommendations. User 110 uses his mobile phone 120 to connect to the cloud 100 and find other users and recommendations. User 110 starts by adding other users that they may know and start performing one of the following actions: Sharing, getting or asking for recommendations.

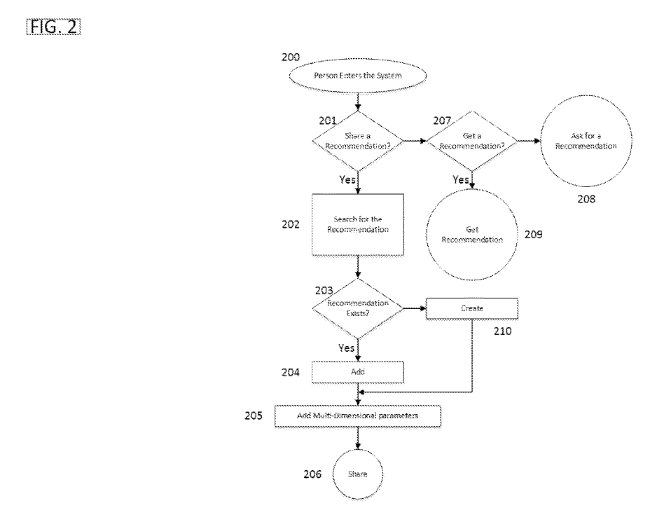

In FIG. 2, the flow diagram shows a person 200 entering the system. First, they choose an action 201. If they decide to share a recommendation, they search 202 if it's in the system. If the recommendation exists 203, they add it 204, if it doesn't exist, they create it 210. In both cases, the user starts adding the multi-dimensional factors 204 of the recommendation, then share 200 the recommendation. The multi-dimensional factors will be explained further in this detailed description.

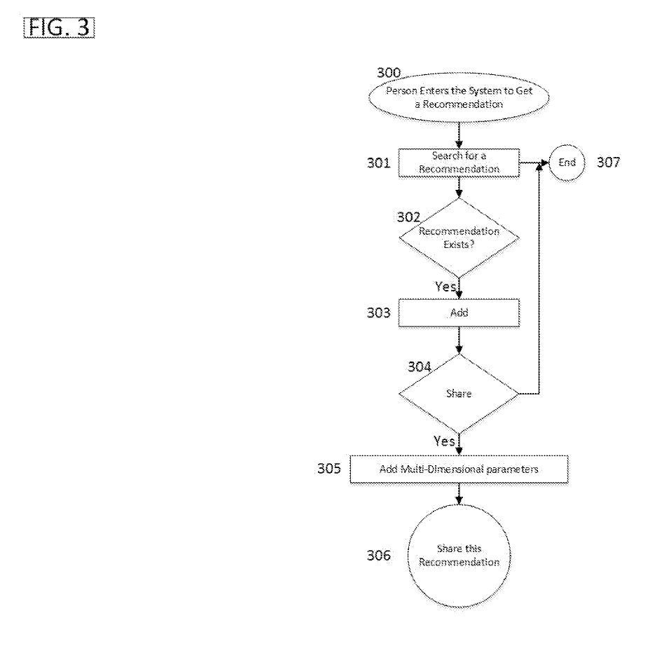

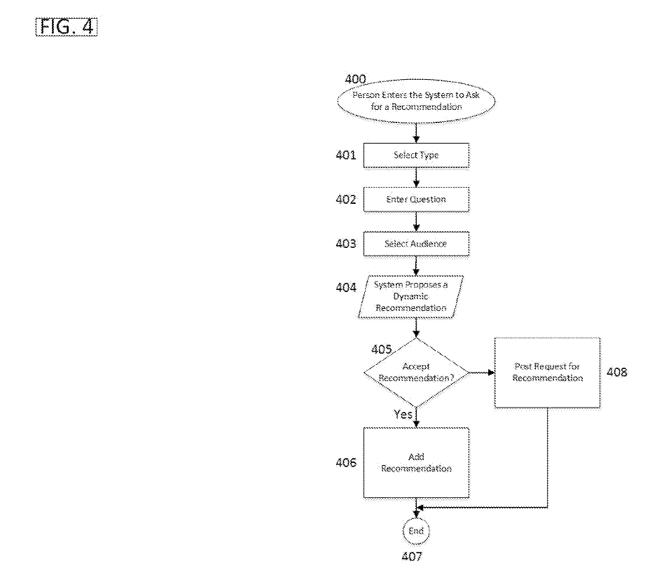

The user 200 also can decide 207 to get a recommendation 209 (Explained in the FIG. 3), or ask for a recommendation 208 (Explained in FIG. 4).

FIG. 3, is also a flow chart that shows that the user 300 has chosen to get a recommendation. They first search for the recommendation they are looking for 301. If the recommendation exists 302, the user 300 adds it 303, then, if the user decides 304 to share it, they add the multi-dimensional parameters 305 and share it 306. Otherwise, the user to not share it, it will be bookmarked and end of process 307. However, if the user search for the recommendation 301 and didn't find it, the process ends 307 or they can start a new search 301.

FIG. 4 is also a flow chart that shows the user 400 entering the system to ask for a recommendation. First, they select the type of recommendation 401 they need. The type could be geo located such as a place or business, or not, such as products, media content such as movies, TV shows, music videos or videos, or it could be books, articles, websites apps and so on. Then, the user enters a question 402 on what they are exactly looking for and also select an audience to whom the question is directed to 403. The audience could be friends, or public. Upon submission, the system proposes dynamic recommendations 404 that it thinks the criteria matches with what they are asking for. The user has a choice to accept 405 the recommendation and add it 406. In this case, the process 407 ends. Or, they don't accept the dynamically generated recommendation and in this case, the user proceeds with posting the question 408 then the process 407 ends.

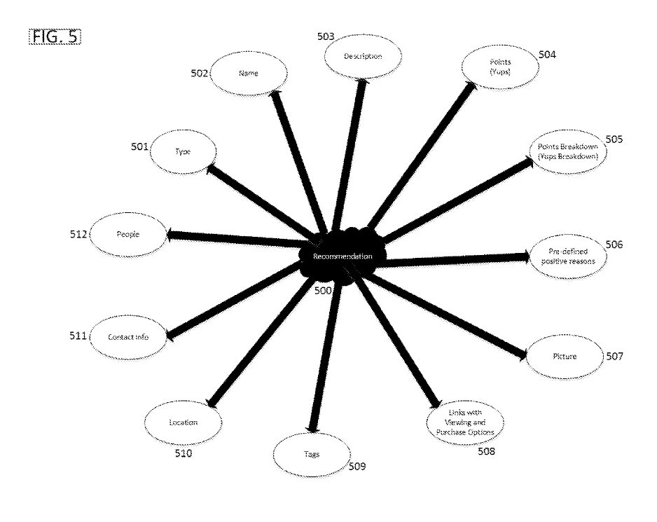

FIG. 5 illustrates the multi-dimensional aspect of a recommendation 500 of the present invention. When a user shares a recommendation, they bring more life to it by adding many parameters that help other people decide whether this recommendation is good for them or not. Therefore, the user starts by giving a type 501 to this recommendation. This could be place, product, movie, music or anything else. Then the user gives a name 502 to help easily identify this recommendation, then a description 503 helps give more information in a textual form for this recommendation. The user then proceeds by selecting how much they like this recommendation using a proprietary scale 504 or points called Yups. One Yup means “Good” and weighs 1, two Yups mean “Great” and weighs 2 and three Yups mean “Awesome” and weighs 3. The recommendation points or Yups breakdown 505 gives a visual indication on how much a recommendation is Great or Awesome or both, or Good. A recommendation that weighs 19 Yups could be broken down to 2 people thinking it's Awesome (+6 Yups), 5 people thinking it's Great (+10 Yups) and 3 people thinking it's Good (+3 Yups), therefore the number 19=(2×3)+(5×2)+(3×1).

The user can then select a set of pre-defined reasons 506 why they like this recommendation. These reasons are different based on the type 501 they have selected. Reasons for a business could be “Clean”, “Helpful”, “Professional” and so on. Reasons for a movie could be “Suspenseful”, “Dramatic”, and so on. This will give other people a quick idea about a recommendation and also, serve as links to other recommendations that have the same commonalities. The user can also attach a picture 507 describing their own experience of this recommendation in a visual manner. Another parameter that helps other people would be links 508 that the user can add that facilitate either purchasing the product or viewing a video about it or listening to a sample music of it etc. . . . The user can also add tags 509 that help link other recommendations related by a certain aspect. For example, in the case of an event, for example the Olympics 2016, a user can add #olympic2016, therefore any other related recommendations can be linked together. The users could share restaurants, articles, music videos all related to the Olympics.

A recommendation can also have a location 510 or a map attached to it. When applicable, other users can easily locate the venue with just a click. The user, can add more contact info 511 if applicable, such as a phone number, an email or so. People can then just call or email to get more info about this recommendation.

Finally, a recommendation will have two sets of people 512 attached to it. In network and out of network. This will help other prospective users make a smart decision based on who else in their network has recommended the same recommendation and what they thought of it based on their multi-dimensional parameters. This help get non-biased positive opinion. Or, should the user choose, they can see why everyone else likes this recommendation.

In one embodiment, a perfect scenario on how the present invention works, would be, a user searches for and adds a restaurant that they would like to recommend to their community. The user then writes a recommendation summary of this restaurant for other community users to view (one of the multi-dimensional factors). The user then adds how much they like this restaurant by adding the Yups proprietary scale. Let's say in this case they choose “Awesome”, which is three Yups (or points) and is based on their satisfaction level (another multi-dimensional factor). The user then adds the reasons that are predefined in the system to quickly tell their impression to other users. In this case, they could probably select “Clean”, “Fast” and “Reasonable” (another multi-dimensional factor). They can then add photos of their experience (another multi-dimensional factor). They could add an address for this restaurant which helps view the map on where it is located (another multi-dimensional factor). The user could add a phone number (another multi-dimensional factor) for others to quickly call this restaurant. Once some or all these multi-dimensional factors are added, a social network page of this restaurant is added to and is associated with this user. It is displayed in the feed and profile page for other connected users to view. Other users can then either click on the restaurant in the feed or can view the profile of the person that created this restaurant review and add a multi-dimensional recommendation themselves.

If others users feel the same or at least like this restaurant, the person who recommended it see their reputation increase by the same number of Yups this restaurant received. For example, a user thinks that this restaurant is great, this restaurant will receive +2 Yups (1: Good, 2: Great, 3: Awesome) and the user who recommended it gets also +2 Yups. That way, both the restaurant and the user who recommended it view their reputation increase.

In another embodiment, a user searches for and adds a pair of running shoes they would like to recommend to their community. The user then writes a recommendation summary of these running shoes for other community users to view (one multi-dimensional factor). The user then tells how much they like the running shoes based on their satisfaction level (another multi-dimensional factor). The user can add set of pre-defined reasons, such as “Light”, “Sturdy” (another multi-dimensional factor), The user then adds a photo of the running shoes (another multi-dimensional factor). The user can also supply a link from where they bought them, to help other users purchase them (another multi-dimensional factor). In the end, a social network page of these running shoes is added to and is associated with this user, and is displayed in the feed and profile page for other connected users to view.

Another embodiment of the present invention, is a user needing a recommendation. They enter the system to “Ask” for a recommendation. They first select the type of recommendation they need. This could be a place, business, product, recipe or any other type that can be recommended. Then they add a description of what exactly they are looking for and proceed. The system then will look for any similarities with the users request and proposes dynamically a set of recommendations. This is another aspect of the present invention. If the user feels one of the recommendations is what they are looking for. They can select it, view it and add. In this case, they won't have to post their question for their friends to answer. If none of the proposed dynamic recommendations fits the user's requirement, they can then proceed by posting their question. All other users in network will receive a notification, based on their preferences: In app notification, push notification and email notification. If any of the users would like to answer, they can directly push one of their recommendations to the asking user, or they can just comment on the question and give some ideas.

1. A method and system for providing location and socially aware multi-dimensional, dynamic, recommendations, the method comprising:
A network based system, a location aware system, a socially aware system;
a component that provides a method to give multi-dimensional, dynamic recommendations on a network server;
a component that provides a method to get multi-dimensional, dynamic recommendations on a network server;
a component that provides a method to search for multi-dimensional, dynamic recommendations on a network server;
a component that provides a method to ask for multi-dimensional, dynamic recommendations on a network server;

2. The method of claim 1, wherein a user accesses the system via a mobile device or a desktop computer.

3. The method of claim 2, wherein a user gives a multi-dimensional, dynamic recommendation

4. The method of claim 3, wherein a user gives a recommendation. These items can include, but are not limited to, Mobile Apps, Articles, Books, Movies, Music, Place, Business, Product, TV Show, Video or a Video Game

5. The method of claim 3, wherein a user writes a textual based name and description for the recommendation

6. The method of claim 3, wherein a user can describe, using a proprietary scale, a recommendation from 1 to 3 yups (low to high). One Yup means good. Two yups means great. Three yups means awesome.

7. The method of claim 3, wherein a user states the pre-defined positive reasons on why they like this recommendation

8. The method of claim 3, wherein a user adds a photo of the recommendation. The photo can either be taken with the mobile device camera or can be an existing photo on the mobile device.

9. The method of claim 3, wherein a user is able to purchase, view, read, listen or download the recommended item based on its type.

10. The method of claim 3, wherein a user creates tags that describe the recommendation.

11. The method of claim 3, wherein a user can add geolocation to allow the recommendation to appear on a map.

12. The method of claim 3, wherein a user can enter contact information for a recommendation.

13. The method of claim 3, wherein a recommendation is tied to other users that have previously recommended it.

14. The method of claim 2, wherein a user gets a recommendation. These items can include, but are not limited to, Mobile Apps, Articles, Books, Movies, Music, Place, Business, Product, TV Show, Video or a Video Game

15. The method of claim 14, wherein a user specifies what type of recommendations they are interested in that will drive what recommendation the system dynamically returns.

16. The method of claim 14, wherein a dynamic recommendation is generated by the system based on its type or viewing or liking by the user from previously generated recommendations.

17. The method of claim 2, wherein a user searches for a recommendation. These items can include, but are not limited to, Mobile Apps, Articles, Books, Movies, Music, Place, Business, Product, TV Show, Video or a Video Game

18. The method of claim 17, wherein a user provides search criteria, such as type of recommendation, hashtags and similar reasons attached to other recommendations.

19. The method of claim 17, wherein the system returns and displays recommendations based on criteria provided.

20. The method of claim 2, wherein a user asks for a recommendation. These items can include, but are not limited to, Mobile Apps, Articles, Books, Movies, Music, Place, Business, Product, TV Show, Video or a Video Game

21. The method of claim 20, wherein a user provides a description of the type of recommendations they are looking for.

22. The method of claim 20, wherein a user asks a question to give more detail on the type of recommendation they are looking for.

23. The method of claim 20, wherein the system based on what the user is looking for will provide, if possible, dynamic recommendations that match the recommendation request.

24. The method of claim 20, wherein the system utilizes algorithms that process data from previously entered recommendations.
